(19) United States
(12) Patent Application Publication
(10) Pub. No.: US 2017/0140665 A1
(43) Pub. Date: May 18, 2017

(54) PHYSICAL CONTACT DEPENDENT FEEDBACK DEVICE

(71) Applicant: Swim Smart, LLC, Iowa City, IA (US)

(72) Inventors: Karl Nicolas Hamouche, Iowa City, IA (US); Michael Thomas Peterson, Stratford, IA (US)

(21) Appl. No.: 15/353,976

(22) Filed: Nov. 17, 2016

Related U.S. Application Data
(60) Provisional application No. 62/256,467, filed on Nov. 17, 2015.

(51) Int. Cl. G09B 19/00; A63B 33/00

(52) U.S. Cl. CPC G09B 19/0038; A63B 33/00

(57) ABSTRACT

A physical contact dependent feedback device is disclosed. The device requires a battery, a feedback member, and at least one sensor attached to a circuit board. All of the components are covered by an enclosure. When the sensor senses physical contact caused by a swimmer performing a correct streamline position, the feedback member is activated. In one embodiment of the present invention, the enclosure has a plurality of protrusions positioned around an outer periphery of a cover of the enclosure and a cover positioned over the circuit board, the battery, the feedback member, and the at least one sensor. In another embodiment, the enclosure is a band.

### CROSS REFERENCE TO RELATED APPLICATION

This application claims the benefit of U.S. Provisional Application No. 62/256,467 filed Nov. 17, 2015.

### BACKGROUND OF THE INVENTION

This invention is directed toward a physical contact dependent feedback device and more particularly a feedback device for training proper swimming techniques. During swimming, a streamline is a position taken with the arms pressed tightly against the head. Many swimmers do not press in the correct position or they do not press hard enough. Human feedback through audible or visual means is unreliable and rarely given, even though the streamline position is performed by swimmers almost constantly during a swim workout or race. In addition, there is no device in existence that responds to the physical contact of the streamline. Therefore, a need exists within the art.

An objective of the present invention is to provide a device that provides consistent and reliable feedback of a swimming technique.

In addition, an objective of the present invention is to provide a device that provides feedback based on physical contact of a correct streamline position. These and other objectives will be apparent to those skilled in the art based upon the following written description, drawings, and claims.

### BRIEF SUMMARY OF THE INVENTION

In general, the present disclosure relates to a physical contact dependent feedback device. The device requires a battery, a feedback member, and at least one sensor attached to a circuit board. All of the components are covered by an enclosure. When the sensor senses physical contact caused by a swimmer performing a correct streamline position, the feedback member is activated. In one embodiment of the present invention, the enclosure has a plurality of protrusions positioned around an outer periphery of a cover of the enclosure and a cover positioned over the circuit board, the battery, the feedback member, and the at least one sensor.

In another embodiment, the enclosure is a band.

### BRIEF DESCRIPTION OF THE DRAWINGS

FIG. 1 is a front view of a physical contact dependent feedback device;

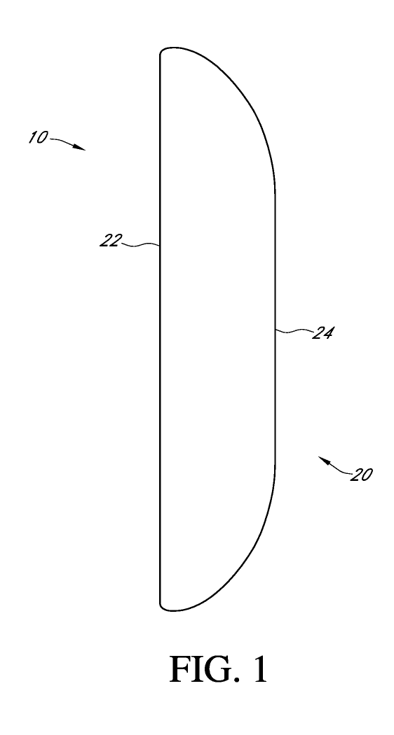

FIG. 2 is a front view of a circuit board of a physical contact dependent feedback device;

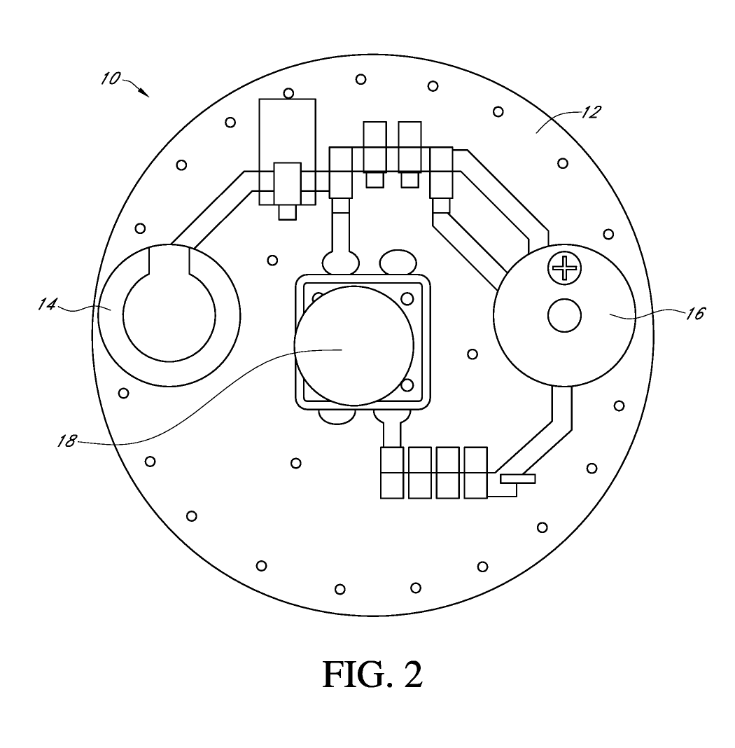

FIG. 3 is a front perspective view of a physical contact dependent feedback device; and

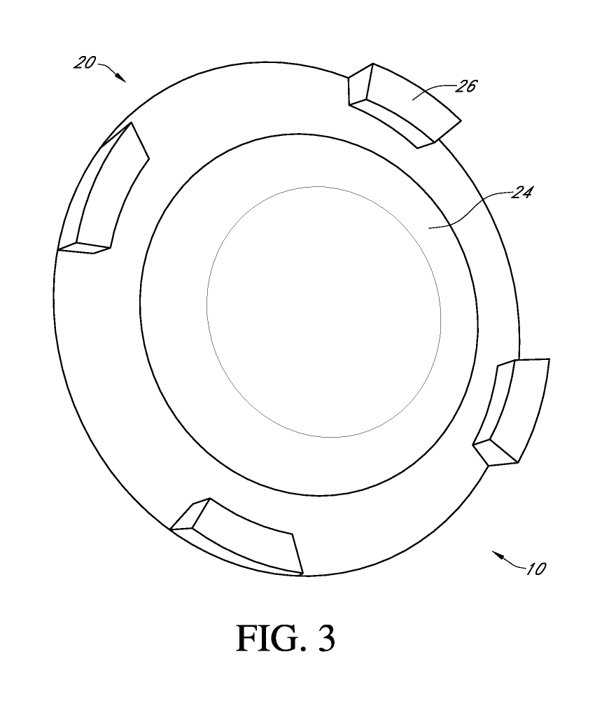

FIG. 4 is a front view of a physical contact dependent feedback device enclosed in a band.

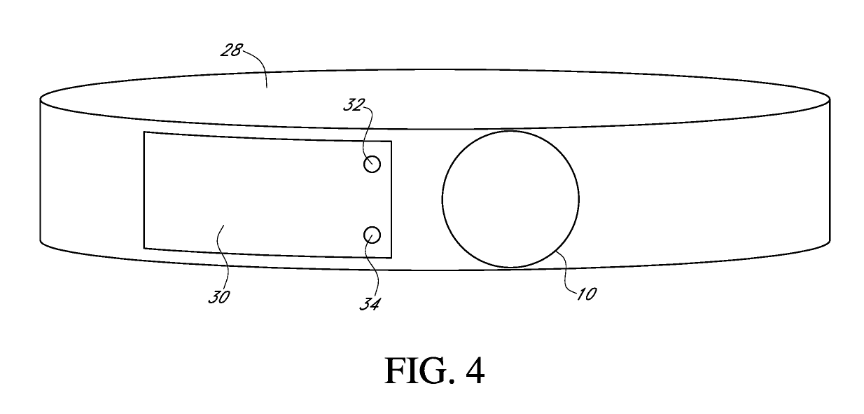

### DETAILED DESCRIPTION OF THE PREFERRED EMBODIMENT

Referring to the Figures a physical contact dependent feedback device 10 has a circuit board 12. Attached to the circuit board 12 is a battery 14. The battery 14 is of any type, such as a coin battery or the like, and in one embodiment rechargeable.

Also attached to the circuit board 12, and electrically connected to the battery 14, is a feedback member 16. The feedback member 16 is of any type, size, and structure that provides a feedback signal upon activation, such as a buzzer, light, speaker or the like. The feedback signal is of any type such as an audio sound, a physical vibration, a visible light flash, or the like.

In addition, at least one sensor 18 is attached to the circuit board 12 and is electrically connected to the battery 14 and the feedback member 16. The sensor 18 is of any type that detects physical contact such as a button, heat sensor, pressure sensor, or light sensor.

The circuit board 12 and attachments 14, 16, and 18 are disposed within an enclosure 20. The enclosure 20 is of any size, shape, and structure and in one example the enclosure 20 has a base 22 and a cover 24. In one embodiment, the base 22 is generally circular and has a plurality of protrusions 26, positioned around an outer periphery, that extend outwardly from one side. The circuit board 12 and attachments 14, 16, and 18 are positioned on the base 22 and the cover 24 is placed over the circuit board 12 and attachments 14, 16, and 18. The cover 24 is attached to the base 22 with adhesive or the like to form a water tight seal. The enclosure 20 is preferably made of a pliable resilient material such as silicone or the like.

In another example, the circuit board 12 and attachments 14, 16, and 18 are enclosed within a band 28 that frictionally engages the sides and back of a swimmer's head. Preferably, at least one circuit board 12 is built into the band 28. Connected to a back portion of the band 28 is a housing 30 formed to receive an mp3 player or the like. The mp3 provides music to the swimmer either through bone conduction or earphones connected to an audio jack 32. The band 28 also has a power jack 34 for recharging the battery 14 attached to the circuit board 12.

In operation, the device 10 is placed on the side of a swimmer's head either underneath a tight fitting swim cap, underneath goggle straps that engage protrusions 26, or by placing the band 28 on the sides and back of the head. In a normal state, no physical pressure is applied to the sensor 18 and the circuit is open resulting in no current flow from the battery 14 to the feedback member 16. When swimming and a correct streamline position is formed, physical pressure is applied to the sensor 18 causing the circuit to close. Once the circuit is closed, current flows from the battery 14 to the feedback member 16, activating the feedback member 16 to produce sound, vibrations, and/or light. Activation of the feedback member 16 remains as long as the swimmer is in a streamline position.

Thus, a physical contact dependent feedback device 10 has been disclosed that, at the very least, meets all the stated objectives.

What is claimed is:

1. A physical contact dependent feedback device, comprising:
a circuit board;
a battery, a feedback member, and at least one sensor attached to the circuit board and in electrical communication; and
an enclosure that covers the circuit board, feedback member, battery, and the at least one sensor.

2. The device of claim 1 wherein the enclosure has a base with protrusions positioned around the outer periphery and a cover positioned within the protrusion to cover the circuit board.

3. The device of claim 1 wherein the feedback member is activated when the at least one sensor detects physical contact when a swimmer is in a streamline position.

4. The device of claim 1 wherein the enclosure is a band.
